(19) United States
(12) Patent Application Publication
(10) Pub. No.: US 2024/0145762 A1
(43) Pub. Date: May 2, 2024

(54) LITHIUM-ION BATTERY

(71) Applicant: ZHUHAI COSMX BATTERY CO., LTD., Zhuhai (CN)

(72) Inventors: Panlong GUO, Zhuhai (CN); Lin CHU, Zhuhai (CN); Suli LI, Zhuhai (CN); Weiping CHEN, Zhuhai (CN)

(73) Assignee: ZHUHAI COSMX BATTERY CO., LTD., Zhuhai (CN)

(21) Appl. No.: 18/398,833

(22) Filed: Dec. 28, 2023

Related U.S. Application Data
(63) Continuation of application No. PCT/CN2022/130417, filed on Nov. 7, 2022.

(30) Foreign Application Priority Data
Nov. 9, 2021 (CN) 202111322507.5

(51) Int. Cl. H01M 10/0525; H01M 4/485; H01M 4/525; H01M 4/62; H01M 10/0568; H01M 10/0569

(52) U.S. Cl. CPC H01M 10/0525; H01M 4/485; H01M 4/525; H01M 4/622; H01M 10/0568; H01M 10/0569; H01M 2300/0034; H01M 2300/0042

(57) ABSTRACT

Disclosed is a lithium-ion battery. The lithium-ion battery comprises a positive electrode, a negative electrode, a separator, and a non-aqueous electrolyte solution. The non-aqueous electrolyte solution at least comprises FEC and PP; the negative electrode comprises a binder; and the binder is a polymer having a side chain containing hydroxyl, and is a graft polymer that one or more of acrylic acid, acrylonitrile, acrylamide, acrylic acid ester, styrene, vinylimidazole, vinylpyridine, sodium p-styrenesulfonate and the like are graft-copolymerized on the hydroxyl. According to the lithium-ion battery of the present disclosure, a stable SEI interface can be formed on a surface of a silicon-based negative electrode, so that the lithium-ion battery prepared thereby has high energy density, long cycle life and low cycle expansion rate.

### CROSS-REFERENCE TO RELATED APPLICATIONS

The present disclosure is a continuation application of International Application No. PCT/CN2022/130417, filed on Nov. 7, 2022, which claims priority to Chinese Patent Application No. CN202111322507.5, filed on Nov. 9, 2021. The disclosures of the aforementioned applications are hereby incorporated by reference in their entireties.

### TECHNICAL FIELD

The present disclosure pertains to the field of lithium-ion battery technologies, and specifically relates to a lithium-ion battery.

### BACKGROUND

In recent years, lithium-ion batteries with high energy density have been a hot topic in scientific and industrial research. Improving energy density of a lithium-ion battery may significantly improve performance of a terminal product, for example, an intelligent electronic product may obtain a longer service life. Improving specific capacity of a material is a major means to improve the energy density of a lithium-ion battery. A theoretical specific capacity of a silicon (Si)-based negative electrode material is as high as 4200 mAh/g, and its lithium intercalation and deintercalation platform is relatively suitable, making it an ideal high-capacity negative electrode material for a lithium-ion battery. However, in a charging and discharging process, a volume expansion of Si may reach 300% or more, and internal stress generated by a violent volume change easily causes pulverization and peeling of a negative electrode, which affects performance and cycle stability of a battery.

In order to improve the volume expansion of the silicon-based negative electrode material, it is also an effective means to adopt a novel binder with good flexibility and strong bonding strength besides modifying the silicon-based negative electrode material itself. At present, most of commercial binders have high bonding rigidity and low flexibility, which have poor volume expansion inhibition effect on the silicon negative electrode, and matching between the binders and an electrolyte solution is poor, and the bonding strength of the binders in the electrolyte solution drops sharply.

Therefore, it is highly desirable to develop a lithium-ion battery with good matching between the binder and the electrolyte solution, low cyclic expansion rate of the silicon-based negative electrode and high cycle retention.

### SUMMARY

In order to improve the shortcomings of the prior art, the present disclosure provides a lithium-ion battery, which has high energy density, excellent cycle life and low cycle expansion rate by improving matching between a binder and an electrolyte solution.

The present disclosure is intended to be implemented by using the following technical solutions.

A lithium-ion battery is provided, and the lithium-ion battery includes a positive electrode, a negative electrode, a separator, and a non-aqueous electrolyte solution, where:
the non-aqueous electrolyte solution at least includes the fluoroethylene carbonate (FEC) and the propyl propionate (PP); and
the negative electrode includes a binder; and the binder is a polymer having a side chain containing hydroxyl, and is a graft polymer that one or more of acrylic acid, acrylonitrile, acrylamide, acrylic acid ester, styrene, vinylimidazole, vinylpyridine, sodium p- styrenesulfonate and the like are graft-copolymerized on the hydroxyl.

According to a specific embodiment, the binder has a structure as shown in Formula 1 or Formula 2:

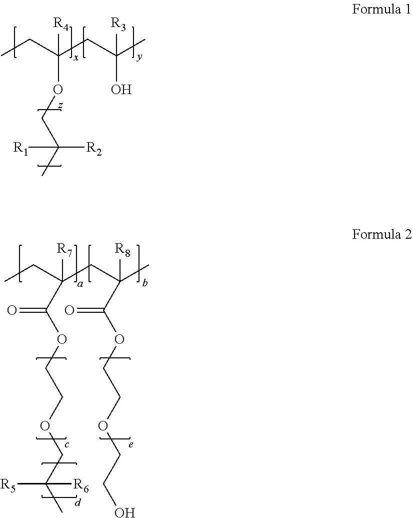

where:
R₁, R₃, R₄, R₅, R₇ and R₈ are the same or different and each independently selected from H and C₁₋₆ alkyl, preferably H and C₁₋₄ alkyl, for example, H, methyl, ethyl, and propyl;
R₂ and R₆ are same or different and are each independently selected from one or more of a carboxylic acid group, an amide group, an ester group, a sulfonic acid group, a phenyl group, an imidazolyl group, a nitrile group or a related group-derived group;
x ranges from 1 to one million, y ranges from 10 to one million, and z ranges from 1 to one million; and
a ranges from 1 to one million, b ranges from 1 to one million, c ranges from 1 to 20 million, d ranges from 10 to one million, and e ranges from 0 to 2000.

In an embodiment, the negative electrode includes a negative electrode active layer, the negative electrode active layer includes the binder, a proportion of a weight of the binder in the negative electrode active layer is A, and a scope of A ranges from 1 wt % to 30 wt %, for example, is 1 wt %, 2 wt %, 3 wt %, 5 wt %, 8 wt %, 10 wt %, 15 wt %, 20 wt %, 25 wt %, or 30 wt %, and preferably ranges from 3 wt % to 30 wt %.

A main function of the binder in the negative electrode of the present disclosure is to make a thickness of a silicon-based negative electrode increase or decrease like a spring when lithium ions are intercalation and deintercalation, but the finally displayed thickness expansion of the battery does not change much through intermolecular force such as hydrogen bonds, Van der Waals' force and the like, and high elastic modulus of the binder.

In an embodiment, in the non-aqueous electrolyte solution, a mass percentage of the fluoroethylene carbonate (FEC) in a total mass of the non-aqueous electrolyte solution is B, and a mass percentage of the propyl propionate (PP) in the total mass of the non-aqueous electrolyte solution is C, then A, B and C need to meet the following relationship: 0.01≤A/B≤10, and 0.01≤A/(B+C)≤0.15.

The present disclosure further adjusts the content A of the binder in the negative electrode slurry, the content B of the fluoroethylene carbonate (FEC) in the electrolyte solution and the content C of the propyl propionate (PP) in the electrolyte solution to make A, B and C meet: 0.01≤A/B≤10, and 0.01≤A/(B+C)≤0.15, so that a stable SEI interface may be formed on a surface of the silicon-based negative electrode, so that cycling performance of the battery is improved. Meanwhile, when the content of the propyl propionate (PP) in the electrolyte solution meets a certain relationship with the content of the binder, a cycle expansion rate of a lithium-ion battery using a silicon-based negative electrode material can also be reduced.

In an embodiment, in the non-aqueous electrolyte solution, a mass percentage of the fluoroethylene carbonate (FEC) in the total mass of the non-aqueous electrolyte solution is B, a scope of B ranges from 1 wt % to 20 wt %, for example, is 1 wt %, 2 wt %, 5 wt %, 8 wt %, 10 wt %, 15 wt %, or 20 wt %, and preferably ranges from 10 wt % to 20 wt %.

In an embodiment, in the non-aqueous electrolyte solution, a mass percentage of the propyl propionate in the total mass of the non-aqueous electrolyte solution is C, a scope of C ranges from 0 wt % to 40 wt % and is not 0 wt %, for example, is 0.1 wt %, 2 wt %, 5 wt %, 8 wt %, 10 wt %, 15 wt %, 20 wt %, 25 wt %, 30 wt %, 35 wt %, or 40 wt %, and preferably ranges from 10 wt % to 40 wt %.

In the present disclosure, the fluoroethylene carbonate (FEC) enables a stable SEI film to be formed on the silicon-based negative electrode, thereby ensuring cycling performance of the battery. However, when the amounts of the propyl propionate (PP) and the binder are within the proportion range defined in the present disclosure, a bonding effect of the binder is better, and a swelling rate of the binder is also lower, so that the cyclic expansion rate of the silicon-based negative electrode can be greatly reduced, and further, the lithium-ion battery using the silicon-based negative electrode material according to the present disclosure can achieve excellent cycling performance and low cycle expansion rate while having high energy density.

In an embodiment, the positive electrode active material in the positive electrode includes one or more of transition metal lithium oxide, lithium iron phosphate, lithium manganate, ternary nickel cobalt manganese, or ternary nickel cobalt aluminum.

In an embodiment, the positive electrode active material in the positive electrode includes lithium cobaltate or lithium cobaltate doped with one or more elements in Al, Mg, Ti, and Zr and/or coated. Illustratively, a chemical formula of the positive electrode active material is Li_{b}Co₁₋ₐMₐO₂; where 0.95≤b≤1.05, 0≤a≤0.1, and M includes one or more of Al, Mg, Ti or Zr.

In an embodiment, the non-aqueous electrolyte solution further includes an electrolyte functional additive. Preferably, the electrolyte functional additive includes one or more of the following compounds: 1,3-propane sultone, 1-propene 1,3-sultone, vinylene carbonate, ethylene sulfate, lithium difluorophosphate, lithium bis(trifluoromethanesulphonyl)imide or lithium bis(fluorosulfonyl)imide.

In an embodiment, the non-aqueous electrolyte solution further includes a non-aqueous organic solvent. Preferably, the non-aqueous organic solvent includes a mixture of at least one cyclic carbonate and at least one of a linear carbonate or a linear carboxylate mixed according to any ratio.

Illustratively, the cyclic carbonate includes at least one of ethylene carbonate or propylene carbonate.

Illustratively, the linear carbonate includes at least one of dimethyl carbonate, diethyl carbonate or ethyl methyl carbonate.

Illustratively, the linear carboxylate includes at least one of ethyl propionate or propyl acetate.

In an embodiment, the non-aqueous electrolyte solution further includes an electrolyte lithium salt. Preferably, the electrolyte lithium salt includes at least one of lithium hexafluorophosphate or lithium perchlorate.

In an embodiment, a concentration of the electrolyte lithium salt in the non-aqueous electrolyte solution ranges from 0.5 mol/L to 2 mol/L, for example, is 0.5 mol/L, 1.0 mol/L, 1.5 mol/L, or 2 mol/L.

In an embodiment, the negative electrode is an electrode on the basis of a silicon-based negative electrode material and/or a carbon-based negative electrode material, for example, the negative electrode material includes one or more of artificial graphite, natural graphite, mesocarbon microbead, hard carbon, soft carbon, nano silicon, a silicon oxide material, or a silicon carbon material.

In an embodiment, the negative electrode material includes one or more of nano silicon, a silicon oxide material or a silicon carbon material.

In an embodiment, a charging cut-off voltage of the lithium-ion battery is 4.45 V or more.

Terms and explanations are as follows.

In the present disclosure, the term “binder” refers to an adhesive in a lithium-ion battery, is high molecular compound, an inactive component in an electrode plate of the lithium-ion battery, and one of important materials that must be used to prepare an electrode plate of the lithium-ion battery. A main function of the “binder” is to connect an electrode active material, a conductive agent, and an electrode collector, so that the three have an overall connectivity, thereby reducing an impedance of electrode, and making an electrode plate have good mechanical and machinable performance, which meets a requirement of actual production.

Beneficial effects of the present disclosure are as follows.

Firstly, the present disclosure provides the lithium-ion battery with high energy density, excellent cycle life and low cycle expansion rate, which includes the positive electrode, the negative electrode, the separator and the non-aqueous electrolyte solution; where the non-aqueous electrolyte solution at least includes the fluoroethylene carbonate (FEC) and the propyl propionate (PP); and the negative electrode includes the binder; and the binder is the polymer having the side chain containing hydroxyl, and is the graft polymer that one or more of acrylic acid, acrylonitrile, acrylamide, acrylic acid ester, styrene, vinylimidazole, vinylpyridine, sodium p- styrenesulfonate and the like are graft-copolymerized on the hydroxyl. By introducing the fluoroethylene carbonate (FEC) and the propyl propionate (PP) into the non-aqueous electrolyte solution and using the binder on the negative electrode, the matching between the binder and the electrolyte solution is improved, so that the stable SEI interface can be formed on the surface of the negative electrode, thus improving the cycling performance of the battery.

Lastly, the polymer containing the hydroxyl (such as polyvinyl alcohol, polymethyl vinyl alcohol, polyhydroxyethyl acrylate, polyhydroxyethyl methyl acrylate, and the like) used in the present disclosure has good flexibility and high tensile strength. The binder of the present disclosure may be prepared by further graft copolymerization using the hydroxyl as an initiation site. The binder of the present disclosure has good flexibility and adhesiveness at the same time, and meanwhile, is graft-copolymerized with other groups such as carboxylic acid groups, which can further endow the binder with excellent properties such as good dispersibility.

### BRIEF DESCRIPTION OF THE DRAWINGS

FIG. 1 is an infrared spectrogram of a PVA-g-P(AA-co-AN) binder prepared in Example 1.

### DETAILED DESCRIPTION OF THE EMBODIMENTS

The present disclosure is further described in detail below with reference to specific embodiments. It should be understood that the following embodiments are merely for the purposes of illustrating and explaining the present disclosure, and should not be construed as limiting the scope of protection of the present disclosure. Any modification or equivalent substitution made to the technical solutions of the present disclosure without departing from the spirit and scope of the technical solutions of the present disclosure shall fall within the protection scope of the present disclosure.

The following describes a cycle life test of a lithium-ion battery prepared.

High-temperature cycle test at 45° C.: a voltage, an internal resistance and a thickness T1 of a battery with 50% SOC obtained after OCV testing were tested first, and then the battery was placed in a constant temperature environment at 45° C. for charging and discharging at a rate of 0.7 C/0.5 C. A cut-off voltage ranged from 3.0 V to 4.48 V (where a charging cut-off voltage was 4.48 V while a discharging cut-off voltage was 3.0 V), and the charging and discharging were repeated for 500 cycles. A cycling discharge capacity was recorded and divided by the first cycling discharge capacity to obtain a cycling capacity retention rate at 45° C. After 500 cycles, the fully-charged battery was taken out of the 45° C. thermostat, a thickness T2 of the battery in a hot and fully-charged state after 500 cycles was immediately measured, a cycling capacity retention rate of the battery at the 500^{th} cycle and a cycling thickness expansion rate of the battery after the 500 cycles were recorded respectively, as shown in Table 3. Where:

Thickness expansion rate (%)=(T2−T1)/T1×100%.

### Comparative Examples 1-15 and Example 1-10

In a manufacturing process of a lithium-ion battery, a corresponding lithium-ion battery was prepared by controlling a content of a PVA-g-P(AA-co-AN) binder in a negative electrode plate and contents of FEC and PP in a non-aqueous electrolyte solution.

All the lithium-ion batteries of Comparative Examples 1-15 and Examples 1-10 had the same preparation process except for the different factors mentioned above, and were as follows:

### (1) Preparation of a Positive Electrode Plate

A positive electrode active material lithium cobalt (LCO), a binder polyvinylidene fluoride (PVDF), and a conductive agent acetylene black were mixed at a weight ratio of 97:1.5:1.5, and were added with N-methylpyrrolidone (NMP). The mixture was stirred under action of a vacuum mixer until a mixed system became a positive electrode slurry with uniform fluidity. The positive electrode slurry was evenly coated on a 10 μm current collector aluminum foil, with a coating surface density of 10 mg/cm². The coated aluminum foil was baked in a five-stage oven with different temperatures (the five different temperatures are 60° C., 80° C., 110° C., 80° C. and 50° C. respectively) and then dried in an oven at 120° C. for 8 hours, followed by calender and cutting, to obtain the required positive electrode plate.

### (2) Preparation of a Negative Electrode Plate

Preparation of PVA-g-P(AA-co-AN) binder: 1 g of polyvinyl alcohol (PVA, molecular weight Mw: 3000, commercialized) was weighed and dissolved in 100 g of deionized water to prepare a solution. Then 0.1 g of Na₂S₂O₈ and 0.03 g of NaHSO₃ initiator were added into the solution and stirred for 10 minutes to generate alkoxy radicals. Acrylic monomer (AA, 4.7 g) and acrylonitrile monomer (AN, 2.3 g) were added under argon protection, and reacted at 60° C. for 3 hours. The reaction products were treated with ethanol and acetone respectively to obtain the final product PVA-g-P(AA-co-AN), the structural formula of which was shown in the following figure:

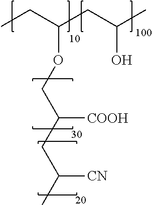

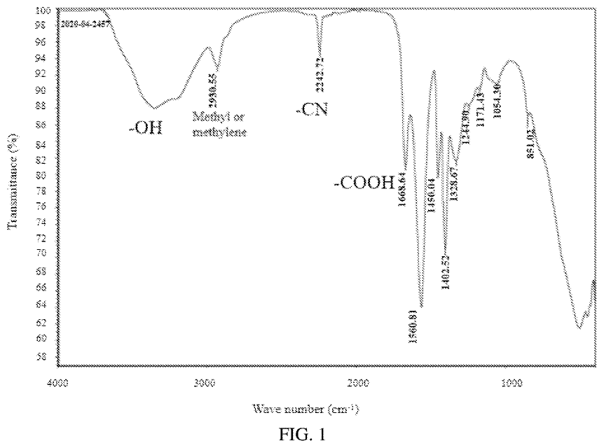

A structure of PVA-g-P(AA-co-AN) was characterized by an infrared spectrum. The results were shown in FIG. 1, from which characteristic peaks of a hydroxyl group, a carboxylic acid group and a nitrile group could be seen, which showed that the PVA-g-P(AA-co-AN) binder was successfully prepared in the present disclosure.

Preparation of a negative electrode plate: A silicon-based negative electrode active material (silicon oxide material), a thickener (sodium carboxymethyl cellulose (CMC-Na)), the PVA-g-P(AA-co-AN) binder, and a conductive agent acetylene black were mixed at a weight ratio of 97:(2-A):A:1, and added into deionized water. The mixture was stirred under action of a vacuum mixer to obtain a negative electrode slurry. The negative electrode slurry was evenly coated on a 6 μm carbon-coated copper foil with high strength with a surface density of 5.1 mg/cm² to obtain a negative electrode plate. The obtained electrode plate was dried at room temperature and then transferred to an 80° C. oven for drying for 10 hours, followed by calender and cutting, to obtain the negative electrode plate.

As a contrast: the negative electrode plates were prepared by using homopolymerized polyvinyl alcohol (PVA, MW: 450,000), polyacrylic acid (PAA, MW: 450,000), polyacrylonitrile (PAN, MW: 400,000) and styrene-butadiene rubber emulsion (SBR, model 451B) as binders and by using the same proportion and process, and a peeling strength of the calender electrode plates was tested. The results are shown in Table 1.

TABLE 1
Peeling strength of negative electrode
plates prepared by using different binders

| Type of binder | Mean peeling strength (N/m) |
|---|---|
| PVA | 6.2 |
| PAA | 5.3 |
| PAN | 7.1 |
| SBR | 8.4 |
| PVA-g-P(AA-co-AN) | 19.3 |

It can be seen from Table 1 that: the mean peeling strength of the Negative electrode plates made of the PVA-g-P(AA-co-AN) binder can reach 19.3 N/m, while the mean peeling strength of the negative electrode plates made of the commercial SBR is only 8.4 N/m, the mean peeling strength of the negative electrode plates made of PVA is only 6.2 N/m, the mean peeling strength of the negative electrode plates made of PAA is only 5.3 N/m, and the mean peeling strength of the negative electrode plates made of PAN is only 7.1 N/m. The PVA-g-P(AA-co-AN) binder has good flexibility and adhesiveness, while the acrylic acid (AA) in the graft-copolymerized P(AA-co-AN) has excellent dispersibility and high mechanical strength, while the acrylonitrile (AN) has good infiltration to the negative electrode active materials and can form strong ion-dipole interaction, which is beneficial to improving the bonding strength of the binder. The structure of the binder integrating rigidity and flexibility prepared by the present disclosure effectively improves the peeling strength of the electrode plates, thus being beneficial to reducing the expansion rate of the silicon-based negative electrode.

### (3) Preparation of an Electrolyte Solution

In a glovebox filled with inert gas (argon) (H₂O<0.1 ppm, O₂<0.1 ppm), ethylene carbonate (EC), propylene carbonate, diethyl carbonate, and propyl propionate (PP) were evenly mixed according to a mass ratio of 3:3:2:2, and then 1.25 mol/L of fully dried lithium hexafluorophosphate (LiPF₆) was quickly added and dissolved in a non-aqueous organic solvent. The mixture was evenly stirred, and a basic electrolyte solution was obtained after passing water content and free acid tests.

### (4) Preparation of a Separator

A polyethylene separator with a mixed coating layer (5 μm+3 μm) having a thickness of 8 μm was selected.

### (5) Preparation of a Lithium-Ion Battery

The positive electrode plate, the separator, and the negative electrode plate prepared above were sequentially stacked to ensure that the separator was located between the positive electrode plate and the negative electrode plate for separation, and then winding was performed to obtain a bare cell without liquid injection. The bare cell was placed in an outer packaging foil, the corresponding prepared electrolyte solution was injected into the dried bare cell, and after processes such as vacuum packaging, standing, forming, shaping, and sorting, a corresponding lithium-ion battery was obtained.

TABLE 2
PVA-g-P(AA-co-AN) binder content as well as
FEC and PP contents in electrolyte solution
in Examples 1-10 and Comparative Examples 1-15

| | Content of | | | | |
|---|---|---|---|---|---|
| | PVA-g- | | | | |
| | P(AA- | Content | Content | | |
| | co-AN) | of | of | | |
| | binder A/% | FEC B/% | PP C/% | A/B | A/(B + C) |
| Example 1 | 1 | 10 | 30 | 0.10 | 0.025 |
| Example 2 | 3 | 10 | 30 | 0.30 | 0.075 |
| Example 3 | 5 | 10 | 30 | 0.50 | 0.125 |
| Example 4 | 3 | 5 | 30 | 0.60 | 0.086 |
| Example 5 | 3 | 15 | 30 | 0.20 | 0.067 |
| Example 6 | 3 | 20 | 30 | 0.15 | 0.060 |
| Example 7 | 3 | 10 | 20 | 0.30 | 0.100 |
| Example 8 | 3 | 10 | 25 | 0.30 | 0.086 |
| Example 9 | 3 | 10 | 35 | 0.30 | 0.067 |
| Example 10 | 3 | 10 | 40 | 0.30 | 0.060 |
| Comparative | 0 | 10 | 30 | 0.00 | 0.000 |
| Example 1 | | | | | |
| Comparative | 7 | 10 | 30 | 0.70 | 0.175 |
| Example 2 | | | | | |
| Comparative | 10 | 10 | 30 | 1.00 | 0.250 |
| Example 3 | | | | | |
| Comparative | 15 | 10 | 30 | 1.50 | 0.375 |
| Example 4 | | | | | |
| Comparative | 3 | 0.1 | 30 | 30.00 | 0.100 |
| Example 5 | | | | | |
| Comparative | 3 | 1 | 30 | 3.00 | 0.097 |
| Example 6 | | | | | |
| Comparative | 3 | 3 | 30 | 1.00 | 0.091 |
| Example 7 | | | | | |
| Comparative | 3 | 25 | 30 | 0.12 | 0.055 |
| Example 8 | | | | | |
| Comparative | 3 | 30 | 30 | 0.10 | 0.050 |
| Example 9 | | | | | |
| Comparative | 3 | 10 | 0 | 0.30 | 0.300 |
| Example 10 | | | | | |
| Comparative | 3 | 10 | 5 | 0.30 | 0.200 |
| Example 11 | | | | | |
| Comparative | 3 | 10 | 10 | 0.30 | 0.150 |
| Example 12 | | | | | |
| Comparative | 3 | 10 | 15 | 0.30 | 0.120 |
| Example 13 | | | | | |
| Comparative | 3 | 10 | 45 | 0.30 | 0.055 |
| Example 14 | | | | | |
| Comparative | 3 | 10 | 50 | 0.30 | 0.050 |
| Example 15 | | | | | |

TABLE 3
Cycle life test results of lithium-ion batteries in Examples 1-10 and Comparative Examples 1-15

| | 100 C | | 300 C | | 500 C | |
|---|---|---|---|---|---|---|
| | Cycling | Thickness | Cycling | Thickness | Cycling | Thickness |
| | retention | expansion | retention | expansion | retention | expansion |
| | rate | rate | rate | rate | rate | rate |
| Example 1 | 87.81% | 15.0% | 73.24% | 23.5% | 55.87% | 37.8% |
| Example 2 | 95.21% | 4.3% | 91.89% | 5.7% | 85.63% | 7.6% |
| Example 3 | 90.34% | 5.4% | 83.47% | 7.3% | 75.81% | 9.4% |
| Example 4 | 85.32% | 10.8% | 76.68% | 13.1% | 63.59% | 16.3% |
| Example 5 | 96.47% | 4.1% | 93.62% | 5.6% | 88.74% | 7.5% |
| Example 6 | 93.23% | 5.3% | 89.71% | 7.2% | 84.45% | 9.4% |
| Example 7 | 89.63% | 10.5% | 85.33% | 13.3% | 80.41% | 16.7% |
| Example 8 | 90.38% | 6.6% | 86.40% | 9.1% | 81.96% | 12.2% |
| Example 9 | 95.78% | 4.6% | 92.01% | 5.8% | 85.84% | 7.7% |
| Example 10 | 92.45% | 7.9% | 88.82% | 9.0% | 81.93% | 10.4% |
| Comparative | 35.80% | 160.0% | / | / | / | / |
| Example 1 | | | | | | |
| Comparative | 85.18% | 5.5% | 76.51% | 7.5% | 66.64% | 9.5% |
| Example 2 | | | | | | |
| Comparative | 81.75% | 6.3% | 71.93% | 8.3% | 62.21% | 10.5% |
| Example 3 | | | | | | |
| Comparative | 75.45% | 8.7% | 63.78% | 10.5% | 50.71% | 12.6% |
| Example 4 | | | | | | |
| Comparative | 45.78% | 130.4% | / | / | / | / |
| Example 5 | | | | | | |
| Comparative | 60.63% | 20.5% | 40.78% | 60.6% | / | / |
| Example 6 | | | | | | |
| Comparative | 70.84% | 16.3% | 60.82% | 24.5% | 45.52% | 36.1% |
| Example 7 | | | | | | |
| Comparative | 88.79% | 6.6% | 80.67% | 8.5% | 70.53% | 10.7% |
| Example 8 | | | | | | |
| Comparative | 86.03% | 7.1% | 77.03% | 9.1% | 65.88% | 11.6% |
| Example 9 | | | | | | |
| Comparative | 82.68% | 35.4% | 74.57% | 40.1% | 63.82% | 45.3% |
| Example 10 | | | | | | |
| Comparative | 83.45% | 21.2% | 76.49% | 25.4% | 66.87% | 30.4% |
| Example 11 | | | | | | |
| Comparative | 86.74% | 17.5% | 80.85% | 21.2% | 73.58% | 25.6% |
| Example 12 | | | | | | |
| Comparative | 88.42% | 14.7% | 83.51% | 17.9% | 77.89% | 21.8% |
| Example 13 | | | | | | |
| Comparative | 90.32% | 9.4% | 87.15% | 10.7% | 79.45% | 13.0% |
| Example 14 | | | | | | |
| Comparative | 88.06% | 10.2% | 84.61% | 11.9% | 74.79% | 15.7% |
| Example 15 | | | | | | |

In the table, / indicates that the battery failed the 300 C and/or 500 C test when the cycling retention rate and thickness expansion rate of the battery were tested.

In Table 2, batteries in Examples 1-3, and Comparative Examples 1-4 are reference group batteries, in which a content of fluoroethylene carbonate (FEC) is fixed to 10%, and a content of propyl propionate (PP) is 30%. In a case that only a content of the PVA-g-P(AA-co-AN) binder is changed, when the content of the PVA-g-P(AA-co-AN) binder gradually increases, A/B and A/(B+C) also exhibit an increasing trend, where ratio ranges of A/B and A/(B+C) in Comparative Examples 1-4 are not in ranges of 0.01≤A/B≤10, and 0.01≤A/(B+C)≤0.15 described in the present disclosure. It is shown from results of the cycle capacity retention rate and the thickness expansion rate in Table 3 that, with a gradual increase in the content of the PVA-g-P(AA-co-AN) binder, both the cycling capacity retention rate and the thickness expansion rate of the batteries show a trend of increasing at first and then decreasing, which is because that an amount of the binder is in a suitable use range, which can make the negative electrode plate have good bonding performance, thus making the prepared lithium-ion battery have better performance, and simultaneously making the cycling thickness expansion of the lithium-ion battery within a normal range. Once the amount of the binder is out of the amount range defined in the present disclosure, due to an increase in a battery impedance, a side reaction on a surface of the negative electrode plate increases correspondingly, performance of the battery deteriorates, and the cycling thickness expansion also increases.

In Table 2, batteries in Examples 4-6, and Comparative Examples 5-9 are reference group batteries, in which a content of PVA-g-P(AA-co-AN) binder is fixed at 3%, and a content of propyl propionate (PP) is fixed at 30%. In a case that only a content of fluoroethylene carbonate (FEC) is changed, when the content of the fluoroethylene carbonate (FEC) gradually increases, A/B and A/(B+C) also exhibit a decreasing trend. It is shown from results of the cycling capacity retention rate and the thickness expansion rate in Table 3 that, with a gradual increase in the content of the fluoroethylene carbonate (FEC), the cycling capacity retention rate of the batteries shows a trend of increasing at first and then decreasing, while the cycling thickness expansion shows a trend of decreasing at first and then increasing. This is because that the fluoroethylene carbonate (FEC) can establish a relatively complete and stable SEI interface on a surface of a silicon-based negative electrode, and the stable SEI interface is helpful to optimize cycling performance of the battery. When an amount of the fluoroethylene carbonate (FEC) reaches an optimal value, the cycling performance of the battery is optimal, and the thickness expansion increase is also in a stable and normal range. When an addition amount of the fluoroethylene carbonate (FEC) is less than an optimal value, an SEI interface is not completely constructed, side reactions of the interface are increased, and a large amount of electrolyte solution is consumed. A solvent is easily reduced on a surface of an electrode plate, and problems such as gas expansion may occur in a battery. Thus, the capacity retention rate of the battery is low and the cycling thickness expansion of the battery is high. When the addition amount of the fluoroethylene carbonate (FEC) is greater than the optimal value, the SEI film on the surface of the electrode plate is too thick, resulting in an increase in the battery impedance and obstruction of a lithium ion transmission rate, which may lead to a lithium precipitation phenomenon in a later stage of battery cycling, thereby affecting the cycling performance of the battery and increasing the cycling thickness expansion of the battery.

In Table 2, batteries in Examples 7-10, and Comparative Examples 10-15 are reference group batteries, in which a content of PVA-g-P(AA-co-AN) binder is fixed at 3%, and a content of fluoroethylene carbonate (FEC) is fixed at 10%. In a case that only a content of propyl propionate (PP) is changed, with the gradual increase in the content of the propyl propionate (PP, A/B is a constant value and A/(B+C) also shows a decreasing trend, where ratio ranges of A/(B+C) in Comparative Examples 10-11 are out of the scope of 0.01≤A/(B+C)≤0.15, as defined in the present disclosure. The cycling capacity retention rates of lithium-ion batteries prepared in this way are lower than those of other lithium-ion batteries, and the cycling thickness expansion thereof is also greater than that of other lithium-ion batteries. It is shown from results of the cycling capacity retention rate and the thickness expansion rate in Table 3 that, with a gradual increase in the content of PP, the cycling capacity retention rate and the cycling thickness expansion of the batteries show a trend of increasing at first and then decreasing. This is because the propyl propionate (PP) plays a role in enhancing the infiltration of the electrode plate in the electrode plate, and meanwhile, the binder may also interact with the propyl propionate (PP). When an amount of the propyl propionate (PP) is relatively small, the binder has a relatively small swelling rate and a relatively small toughness in an electrolyte solution, thus making a silicon-based negative electrode have a relatively large thickness expansion rate in a charging and discharging process. When the amount of the propyl propionate (PP) is in an appropriate use range, swelling of the binder in the electrolyte solution reaches an appropriate degree. In this case, the toughness of the binder is the largest, and the thickness expansion rate of the silicon-based negative electrode in a charging/discharging process is large, the binder in this case can function as a spring, and an electrode plate in the battery is bonded well. In addition, an appropriate amount of the content of the fluoroethylene carbonate (FEC) also enables the battery to form an SEI interface. Therefore, cycling performance of the battery is better, and the cycling thickness expansion of the battery is also within a normal range. However, when the content of the propyl propionate (PP) is too high, the swelling of the binder is too high, which affects the function of the binder. At the same time, the stability of the propyl propionate (PP) with a high content at high temperature and high voltage is poor, which affects the cycling capacity retention rate and the cycle thickness expansion rate of the battery.

To sum up, it can be seen that the lithium-ion battery disclosed by the present disclosure has high energy density, excellent cycle life and low cycling thickness expansion rate, and shows extremely high application value.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

What is claimed is:

1. A lithium-ion battery, comprising a positive electrode, a negative electrode, a separator, and a non-aqueous electrolyte solution, wherein:
the non-aqueous electrolyte solution at least comprises fluoroethylene carbonate and propyl propionate; and
the positive electrode comprises a binder; and the binder is a polymer having a side chain containing hydroxyl, and is a graft polymer that one or more of acrylic acid, acrylonitrile, acrylamide, acrylic acid ester, styrene, vinylimidazole, vinylpyridine, sodium p- styrenesulfonate and the like are graft-copolymerized on the hydroxyl.

2. The lithium-ion battery according to claim 1, wherein the binder has a structure as shown in Formula 1 or Formula 2: [symbol]
wherein:
R₁, R₃, R₄, R₅, R₇ and R₈ are each independently selected from H and C₁₋₆ alkyl;
R₂ and R₆ are each independently selected from one or more of a carboxylic acid group, an amide group, an ester group, a sulfonic acid group, a phenyl group, an imidazolyl group, a nitrile group or a related group-derived group;
x ranges from 1 to one million, y ranges from 10 to one million, and z ranges from 1 to one million; and
a ranges from 1 to one million, b ranges from 1 to one million, c ranges from 1 to 20 million, d ranges from 10 to one million, and e ranges from 0 to 2000.

3. The lithium-ion battery according to claim 1, wherein the negative electrode comprises a negative electrode active layer, the negative electrode active layer comprises the binder, a proportion of a weight of the binder in the negative electrode active layer is A, and a scope of A ranges from 1 wt % to 30 wt %.

4. The lithium-ion battery according to claim 3, wherein the scope of A ranges from 3 wt % to 30 wt %.

5. The lithium-ion battery according to claim 1, wherein in the non-aqueous electrolyte solution, a mass percentage of the fluoroethylene carbonate in a total mass of the non-aqueous electrolyte solution is B, and a mass percentage of the propyl propionate in the total mass of the non-aqueous electrolyte solution is C, then A, B and C meet the following relationship: 0.01≤A/B≤10, and 0.01≤A/(B+C)≤0.15.

6. The lithium-ion battery according to claim 1, wherein in the non-aqueous electrolyte solution, a mass percentage of the fluoroethylene carbonate in the total mass of the non-aqueous electrolyte solution is B, and a scope of B ranges from 1 wt % to 20 wt %.

7. The lithium-ion battery according to claim 6, wherein the scope of B ranges from 10 wt % to 20 wt %.

8. The lithium-ion battery according to claim 1, wherein in the non-aqueous electrolyte solution, a mass percentage of the propyl propionate in the total mass of the non-aqueous electrolyte solution is C, and a scope of C ranges from 0 wt % to 40 wt %, and is not 0 wt %.

9. The lithium-ion battery according to claim 8, wherein the scope of C ranges from 10 wt % to 40 wt %.

10. The lithium-ion battery according to claim 1, wherein a positive electrode active material in the positive electrode comprises one or more of transition metal lithium oxide, lithium iron phosphate, lithium manganate, ternary nickel cobalt manganese, or ternary nickel cobalt aluminum; and/or
the positive electrode active material in the positive electrode comprises lithium cobaltate or lithium cobaltate doped with one or more elements in Al, Mg, Ti, or Zr and/or coated .

11. The lithium-ion battery according to claim 1, wherein the non-aqueous electrolyte solution further comprises an electrolyte functional additive, and the electrolyte functional additive comprises one or more of the following compounds: 1,3-propane sultone, 1-propene 1,3-sultone, vinylene carbonate, ethylene sulfate, lithium difluorophosphate, lithium bis(trifluoromethanesulphonyl)imide or lithium bis(fluorosulfonyl)imide.

12. The lithium-ion battery according to claim 1, wherein the non-aqueous electrolyte solution further comprises a non-aqueous organic solvent.

13. The lithium-ion battery according to claim 1, wherein the non-aqueous organic solvent comprises a mixture of at least one of cyclic carbonate and at least one of a linear carbonate or a linear carboxylate mixed according to any ratio.

14. The lithium-ion battery according to claim 13, wherein the cyclic carbonate comprises at least one of ethylene carbonate or propylene carbonate; and/or
the linear carbonate comprises at least one of dimethyl carbonate, diethyl carbonate or ethyl methyl carbonate; and/or
the linear carboxylate comprises at least one of ethyl propionate or propyl acetate.

15. The lithium-ion battery according to claim 1, wherein the non-aqueous electrolyte solution further comprises an electrolyte lithium salt.

16. The lithium-ion battery according to claim 15, wherein the electrolyte lithium salt comprises at least one of lithium hexafluorophosphate or lithium perchlorate; and/or
a concentration of the electrolyte lithium salt in the non-aqueous electrolyte solution ranges from 0.5 mol/L to 2 mol/L.

17. The lithium-ion battery according to claim 1, wherein the negative electrode is an electrode on the basis of a silicon-based negative electrode material and/or a carbon-based negative electrode material.

18. The lithium-ion battery according to claim 17, wherein the negative electrode material comprises one or more of artificial graphite, natural graphite, mesocarbon microbead, hard carbon, soft carbon, nano silicon, a silicon oxide material, or a silicon carbon material.

19. The lithium-ion battery according to claim 18, wherein the negative electrode material comprises one or more of the nano silicon, the silicon oxide material or the silicon carbon material.

20. The lithium-ion battery according to claim 1, wherein a charging cut-off voltage of the lithium-ion battery is 4.45 V or more.
